(19) United States
(12) Patent Application Publication
(10) Pub. No.: US 2021/0300629 A1
(43) Pub. Date: Sep. 30, 2021

(54) REUSABLE SELF-OPENING T-SHIRT BAG APPARATUS AND METHODS OF MANUFACTURE THEREOF

(71) Applicant: New York Packaging II, LLC, New Hyde Park, NY (US)

(72) Inventor: Jeffrey RABIEA, New Hyde Park, NY (US)

(21) Appl. No.: 16/835,260

(22) Filed: Mar. 30, 2020

(51) Int. Cl. B65D 33/06; B31B 70/86

(52) U.S. Cl. CPC B65D 33/065; B65D 33/007; B31B 70/872

(57) ABSTRACT

A bag apparatus includes a first bag wall, sides, a bottom, and an opening. Handles extend from the opening a define slits for hanging on a dispenser. A tab is disposed between the handles and extends from the bag at the opening. The tab includes a slit for handing on a dispenser. The bag and tab are configured to permit opening of the bag with pulling with a first force when the bag is mounted on a rack, and separation of the bag at the tab with pulling with a second force stronger than the first force.

### FIELD

The disclosure is directed to pouches or bags. In particular, the disclosure relates to flexible, reusable pouches or bags having handles and that are collapsible and self-opening when on a dispensing rack.

### BACKGROUND

Conventional, single use plastic bags used around the world for shopping have an enormous impact on the environment because they contribute to vast amounts of waste. Single use plastic bags are desired because they are inexpensive, light, and flexible enough to easily conform to goods and fold compactly for packaging, and yet strong enough to support a full load of goods. Accordingly, reusable bags having suitable weight, thickness, flexibility, and durability have been developed using various woven or non-woven synthetic fabric.

For example, “t-shirt bags” are shopping bags with handles extending upward from a top of the bag. Reusable t-shirt bags are commercially available. T-shirt bags are often provided in stacks having holes through the handle portions of the stack. The stack is arranged on the dispenser rack by dispenser rods extending through the holes. Some t-shirt bags include a set of tabs centrally located between the two handles, each tab on an opposite side of the bag opening. The tabs define respective openings through which a third rod or similar device extends. Accordingly, support may be provided for the bag during hanging and removal.

### SUMMARY

A need has been recognized for t-shirt bags with handles and central support tabs that have improved ease of use. In particular, a need has been recognized for reusable t-shirt having a strength sufficient for multiple while having a thin profile, flexibility, and a manufacturing cost corresponding with costs of, and thus competitive to, conventional single use bags. A bag having flexible profile, a handle, and a strength and durability suitable for multiple, repeated bag uses while having a manufacturing cost and material cost competitive with conventional bags is disclosed. Further, a need has been recognized for a bag providing improved ease of use and functionality by automatically opening for filling during removal from a dispenser rack.

A t-shirt bag apparatus is disclosed that provides easier and more manageable opening for use. Bag apparatus and methods of manufacture thereof in accordance with embodiments disclosed herein meet these needs and demands.

Bag apparatus and methods of manufacture thereof in accordance with embodiments of the disclosure enable efficient use of packaging materials, minimizing packing costs, maximizing utility, and minimizing environmental impact of disposable bag and pouch usage. Reusable bags in accordance with embodiments of the disclosure are configured for compact folding, and include a handle pair and a tab for hanging on a dispenser rack, the tab located on a single side of the bag.

In an embodiment, the bag or pouch is formed of suitable material, which may be woven or non-woven. In an embodiment, the material comprises polyethylene. For example, the polyethylene may be recycled. In embodiments, the material may comprise polypropylene.

The bags or pouches may be cut and constructed to be any suitable size or shape. In an embodiment, a thickness of the bag lies in a range of thicknesses, measured in units of gram weights, of 30 grams per square meter to 150 grams per square meter, for example. The bag apparatus has handles and is foldable for efficient storage and flexible for conformability to contents. The handles are configured for removable mounting on a dispenser rack.

In an embodiment, the bag includes a top portion defining an opening formed by sides of the bag and a back panel, and a front panel of the bag. The back panel comprises a tab centrally located and extending upward in a direction parallel to the handles. The tab is configured for removable mounting on the dispenser rack. For example, a dispenser rack may comprise two rods configured to extend through slits or openings defined by the handles. The dispenser rack may comprise a third rod configured to extend through a slit or opening defined by the tab.

In an embodiment, a bag apparatus includes a first bag wall; a first side panel; a second side panel; a second bag wall aligned and joined to the first bag wall by the first side panel and the second side; a bag bottom; a first handle extending from the first bag wall and the second bag wall; a second handle extending from the first bag wall and the second bag wall; and a tab extending from the first bag wall and defining an opening. In an embodiments, the tab extends only from a single side of the bag. In some embodiments, multiple tabs may extend from the same single side of the bag. The opposite side of the bag is free of such tabs. In an embodiment, the opening of the tab further includes a slit. In an embodiment, the first handle includes an opening defined by the first handle. In an embodiment the second handle defines an opening. The handles may be loops. The openings may be configured for securing the bag on a dispenser rack.

In an embodiment, methods include providing a planar, flexible sheet; forming a pair of handles; and forming a tab defining an opening configured for securing on a dispenser rack. Methods may include forming holes or openings defined in the handles for securing on a dispenser rack. Methods may include forming the hole in the tab. In another embodiment, methods include forming perforations, or an otherwise separable portion in the tab to permit separation from the bag.

Additional features and technical effects of the present disclosure will become readily apparent to those skilled in the art from the following detailed description wherein embodiments of the present disclosure are described simply by way of illustration of the best mode contemplated to carry out the present disclosure. In addition to the embodiments disclosed herein, other and different embodiments are within the spirit and scope of the disclosure, and its several details are capable of modifications in various respects.

### BRIEF DESCRIPTION OF DRAWINGS

The disclosure is shown by way of example in the figures of the accompanying drawings, in which like reference numerals refer to like elements.

FIG. 1 shows a front perspective view of a bag in accordance with an embodiment;

FIG. 2 shows a back perspective view a bag in accordance with an embodiment;

FIG. 3 shows a top view of a bag in accordance with an embodiment;

FIG. 4 shows a bottom view of a bag in accordance with an embodiment;

FIG. 5 shows a side view of a bag in accordance with an embodiment;

FIG. 6 shows a front view of a bag in accordance with an embodiment;

FIG. 7 shows a back view of a bag in accordance with an embodiment;

FIG. 8 shows a method useful for manufacturing a bag in accordance with an embodiment;

FIG. 9A shows a method of using a bag in accordance with an embodiment;

FIG. 9B shows a method of using a bag in accordance with an embodiment.

### DETAILED DESCRIPTION OF EMBODIMENTS

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

Embodiments of bag apparatus and methods of manufacture thereof are disclosed. Apparatus of embodiments advantageously include a bag having handles and a stab extending from a single side of the bag at the top or open end thereof. The tab configuration facilitates support of the bag on a dispenser rack while permitting a front of the bag to be pulled forward to separate from the back of the bag, which is secured to the rack by the tab. The bag may have handles also configured to mount the bag on the dispenser. For example, the handles may define slits or openings through which rods of a dispenser rack pass through. The bag may thus be supported by the dispenser rack, with a back portion held stationary during separation by a user of the front of the bag from the back of the bag. Accordingly, the bag may be held in an open position on the rack for filling the bag with items. In an embodiment, the tab may be centrally disposed between two handles.

In an embodiment, the tab be configured to tear away from the bag when the bag is removed from a dispenser rack. For example, material connecting the bag to the tab may be perforated, or otherwise weakened by now known or later developed methods, for enabling tear-away separation of the tab from the bag with sufficient force.

In embodiments, a reusable bag configured for flexibility and conformability, and formed of any now known or later developed material, including woven or non-woven polymeric material, such as, for example polypropylene, or polyethylene is implemented. For the example, the bag wall material may comprise recycled polyethylene. Consumer demand for plastic bags has previously been met by providing thin plastic bags that are flexible, light, and inexpensive, but at the expense of durability and typically configured limited or single use. Recently, consumer demand has increasingly required flexible, thin, and light bags having sufficient strength for multiple uses. Reusable bags with handles and having flexibility, and minimal materials and manufacturing costs are disclosed.

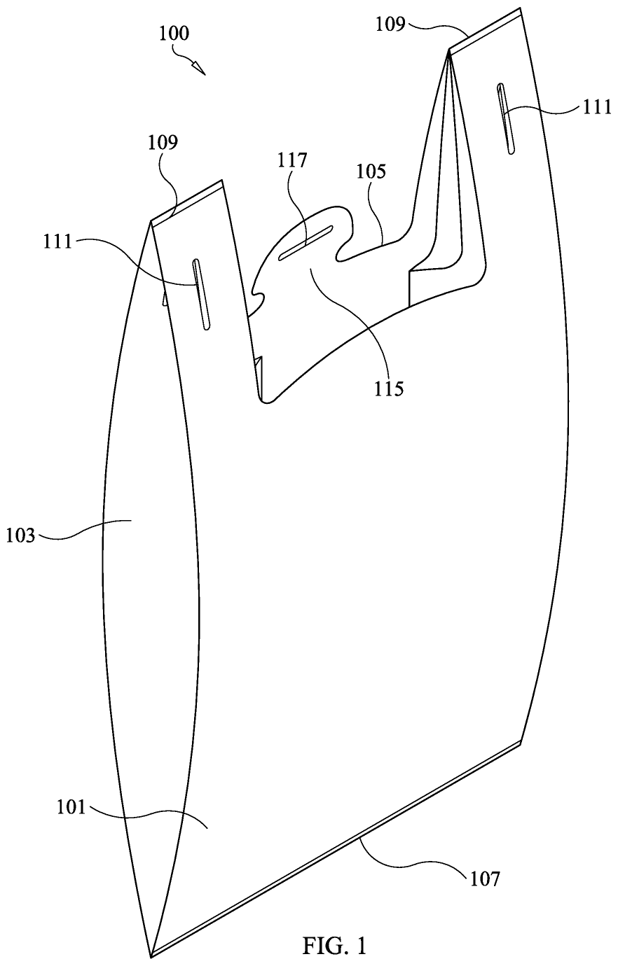

A reusable bag with handles is shown in FIG. 1. In particular, FIG. 1 shows a front, top perspective view of a bag 100 including a bag body including a first wall aligned and joined to a second wall, forming two sides 103, a top 105, and a bottom 107, leaving an open unsealed edge at the top 105. The walls may be formed of any now known or later developed material such as polypropylene and polyethylene. The first wall and the second wall may be formed of the same material, and the sides 103 and the bottom 107 may be formed of the same material as the walls. The sheet material may be clear, colored, or printable, woven or non-woven.

A thickness of the sheets or bag walls may be any useful thickness, and preferably have a thin profile. In some embodiments, a polypropylene fabric bag includes walls and a bottom each having a thickness lying in a range of 0.0002 inches through 0.0040 inches. In some embodiments, a thickness of a polypropylene non-woven bag bag is selected from a range of thicknesses, measured in units of gram weights, from 30 grams per square meter to 150 grams per square meter.

In embodiments, a bag 100 is formed of a single sheet that is folded and configured to form the first wall, the second wall, the side panels 103, and the bottom 107. The side panels 103 and the bottom 107 are constructed and arranged to form fold lines. The fold lines or creases are formed to cause the bag to readily collapse into a folded configuration, and to readily expand into an open configuration.

FIG. 1 shows a pair of handles 109 extending from the bag body 101 in a direction away from the top portion 105 and the bottom 107 of the bag body 101. The handles 109 define openings 111 through which, for example, rods or similarly constructed and arranged components of a dispenser rack (not shown) extend for support of the bag 100 on the dispenser rack. The openings may be in the form of round roles, rectangular or square holes, or slits as shown, or any other suitably formed and arranged opening.

FIG. 1 shows a tab 115 disposed centrally between the handles 111. The tab is disposed on only a single side of the bag body 101. The tab 115 is formed of the same material as the bag body in FIG. 1. The tab 115 defines an opening 117 through which, for example, rods or similarly constructed and arranged components of a dispenser rack extend fro support of the bag 100 on the dispenser rack. In some embodiments, the tab 115 may be configured to tear away from the remainder of the bag body 101. For example, the tab 115 may be perforated along a section separating the tab 115 from the bag body 101. In some embodiments, the tab 115 may be centrally disposed at the top portion 105 of the bag body 101.

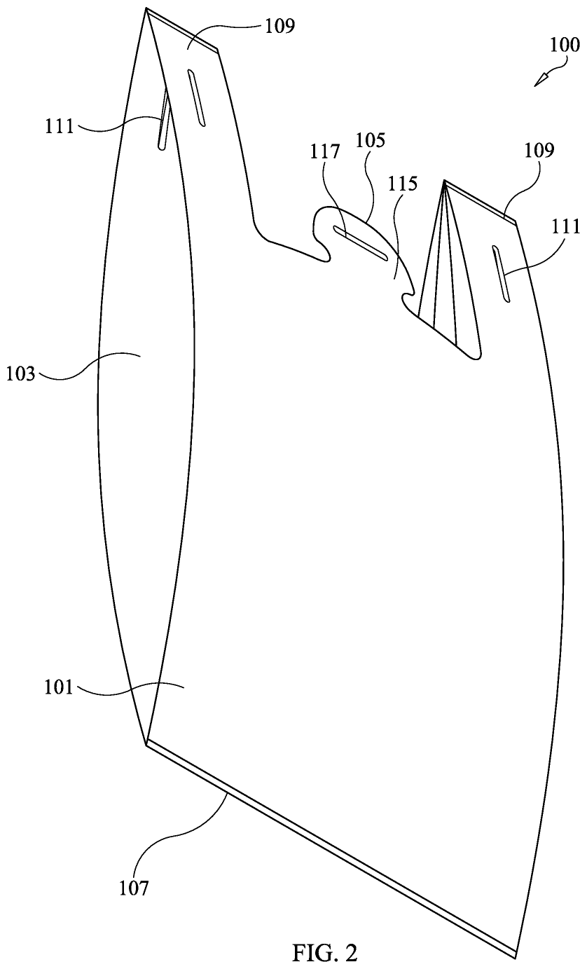

FIG. 2 shows a back, bottom perspective of the bag 100 shown in FIG. 1. In particular, FIG. 2 shows a bottom perspective view of a bag 100 including a bag body including a first wall aligned and joined to a second wall, forming two sides 103, a top 105, and a bottom 107, leaving an open unsealed edge at the top 105. The walls may be formed of any now known or later developed material such as polypropylene and polyethylene. The first wall and the second wall may be formed of the same material, and the sides 103 and the bottom 107 may be formed of the same material as the walls.

FIG. 2 shows a pair of handles 109 extending from the bag body 101 in a direction away from the top portion 105 and the bottom 107 of the bag body 101. The handles 109 define openings 111 through which, for example, rods or similarly constructed and arranged components of a dispenser rack (not shown) extend for support of the bag 100 on the dispenser rack. The openings may be in the form of round roles, rectangular or square holes, or slits as shown, or any other suitably formed and arranged opening.

FIG. 2 shows a tab 115 disposed centrally between the handles 111. The tab is disposed on only a single side of the bag body 101. The tab 115 is formed of the same material as the bag body in FIG. 1. The tab 115 defines an opening 117 through which, for example, rods or similarly constructed and arranged components of a dispenser rack extend for support of the bag 100 on the dispenser rack.

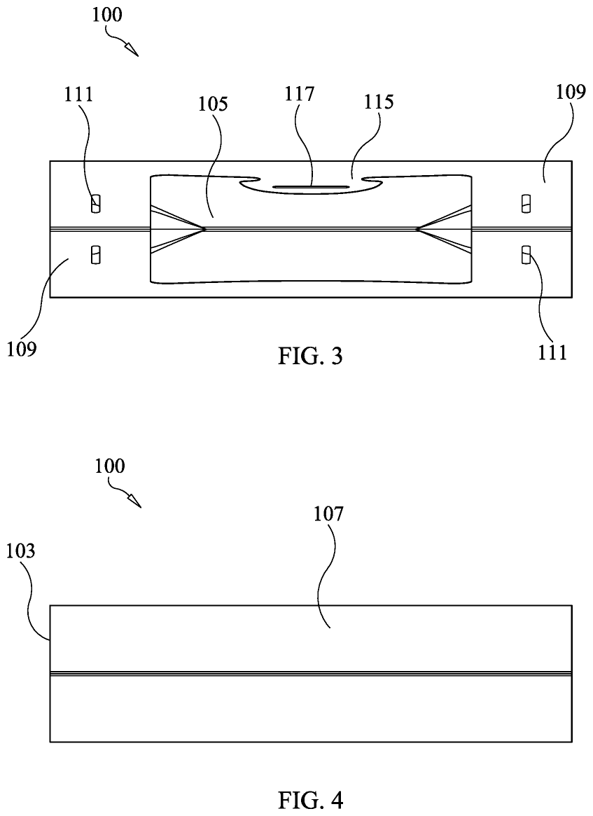

FIG. 3 a top view of a bag in accordance with an embodiment. In particular, FIG. 3 shows a bag 100 having a top portion 105 defined by the bag, and handles 109 extending therefrom. The handles 109 define openings, or slits 111. FIG. 3 shows a centrally disposed tab 115 extending from the top portion 105. The tab 115 defines an opening or slit 117.

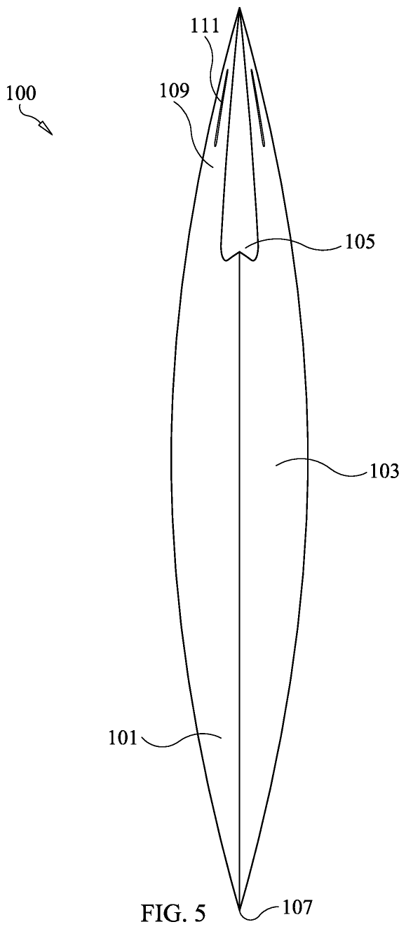

FIG. 4 shows a bottom view of a bag in accordance with an embodiment. In particular, FIG. 4 shows a bag 100 having sides 103 and a bottom 107.

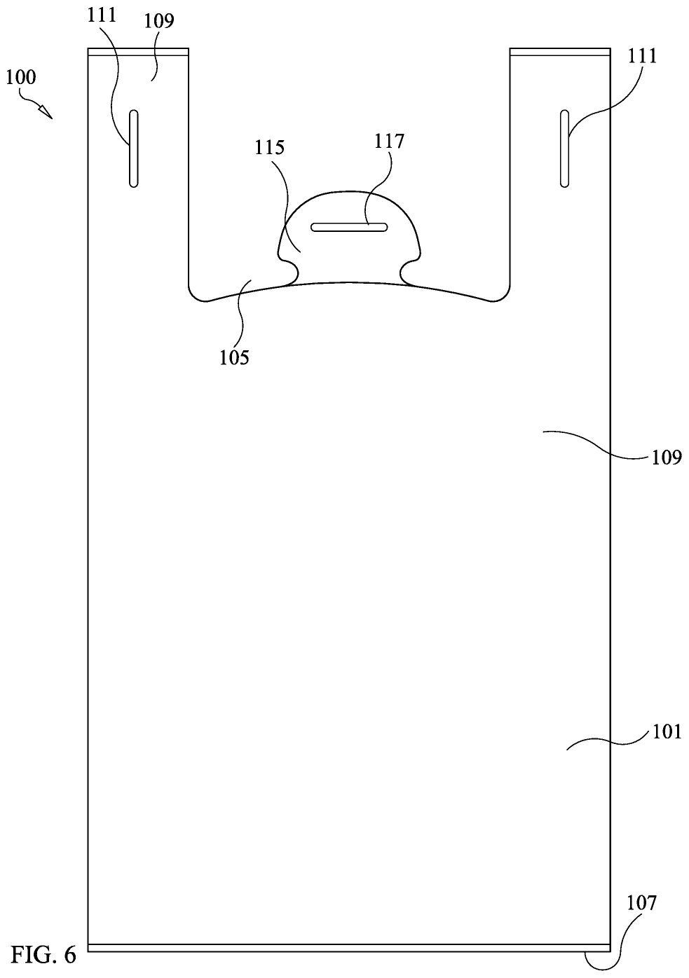

FIG. 5 shows a side view of a bag in accordance with an embodiment. In particular, FIG. 5 shows a bag 100 including a body 101, a top portion 105, and a bottom 107. FIG. 5 shows a handle 109 defining openings 111.

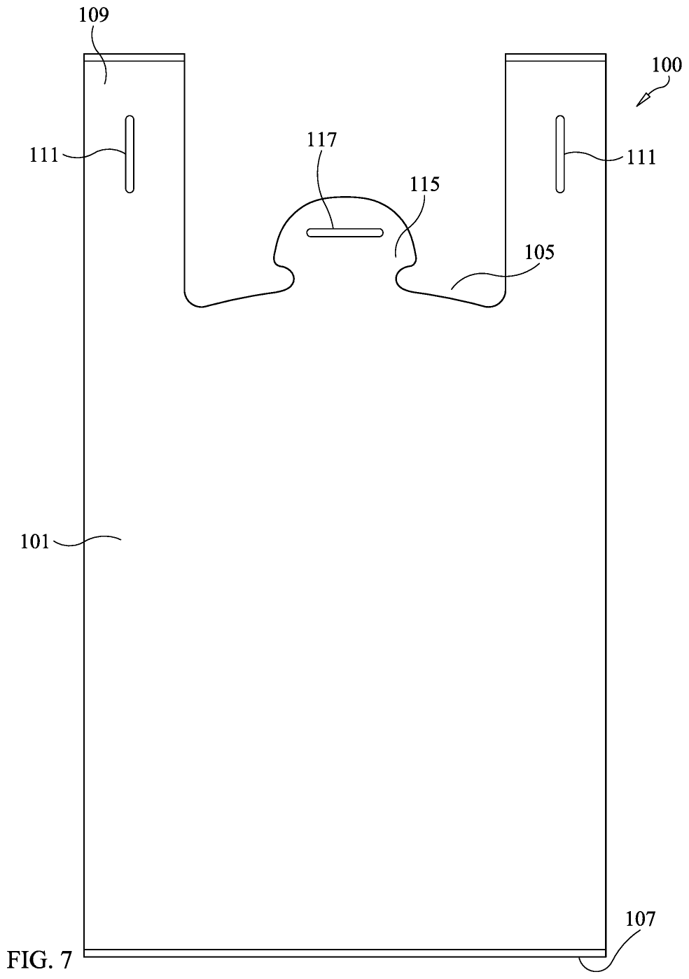

FIG. 6 shows a front view of a bag in accordance with an embodiment. In particular, FIG. 6 shows a bag 101 including a bag body 101, a top portion 105, a bottom 107, and a pair of handles 109 extending from the bag body 101 in a direction away from the top portion 105 and the bottom 107 of the bag body 101. The handles 109 define openings 111 through which, for example, rods or similarly constructed and arranged components of a dispenser rack (not shown) extend for support of the bag 100 on the dispenser rack. The openings may be in the form of round roles, rectangular or square holes, or slits as shown, or any other suitably formed and arranged opening.

FIG. 6 shows a tab 115 disposed centrally between the handles 111. The tab is disposed on only a single side of the bag body 101. The tab 115 is formed of the same material as the bag body 101. The tab 115 defines an opening 117 through which, for example, rods or similarly constructed and arranged components of a dispenser rack extend for support of the bag 100 on the dispenser rack.

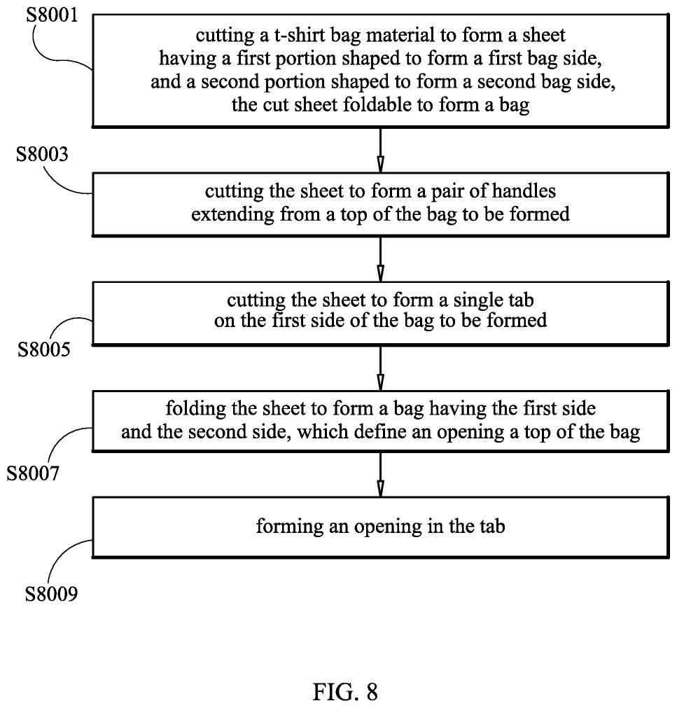

FIG. 7 shows a back view of a bag in accordance with an embodiment. In particular, FIG. 7 shows a back view of the bag 100 shown in FIG. 7. In particular, FIG. 7 shows a bag 101 including a bag body 101, a top portion 105, a bottom 107, and a pair of handles 109 extending from the bag body 101 in a direction away from the top portion 105 and the bottom 107 of the bag body 101. The handles 109 define openings 111 through which, for example, rods or similarly constructed and arranged components of a dispenser rack (not shown) extend for support of the bag 100 on the dispenser rack. The openings may be in the form of round roles, rectangular or square holes, or slits as shown, or any other suitably formed and arranged opening.

FIG. 7 shows a tab 115 disposed centrally between the handles 111. The tab is disposed on only a single side of the bag body 101. The tab 115 is formed of the same material as the bag body 101. The tab 115 defines an opening 117 through which, for example, rods or similarly constructed and arranged components of a dispenser rack extend for support of the bag 100 on the dispenser rack.

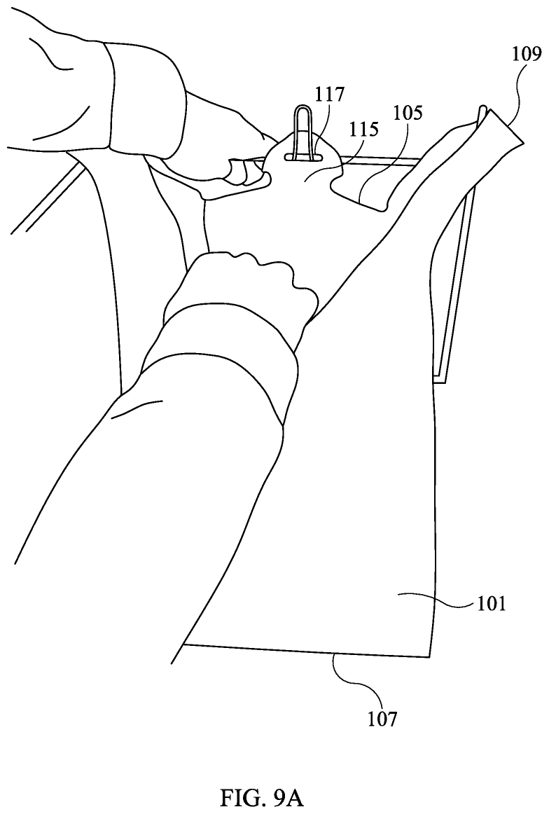

FIG. 8 shows processes in accordance with methods of forming a bag in accordance with an embodiment. In particular, FIG. 8 shows methods including a step S8001 cutting a t-shirt bag material to form a sheet having a first portion shaped to form a first bag side, and a second portion shaped to form a second bag side, the cut sheet foldable to form a bag. Methods include a step S8003 of cutting the sheet to form a pair of handles extending from a top of the bag.

Further, methods include a step S8005 of cutting the sheet to form a tab on the first side of the bag. The tab extends from the top portion of the bag at the opening. Methods include a step S8007 of folding the sheet to form a bag having the first side and the second side, which together define the opening at the top of the bag. In embodiments, the tab is located on only a single side of the bag. In some embodiments, multiple tabs may be formed on the single side of the bag. No such tab is formed on the opposite side of the bag to retain the opposite to the rack during opening and filling of the bag.

Methods include a step S8009 of forming an opening in the tab. Further, methods include forming openings in the handles.

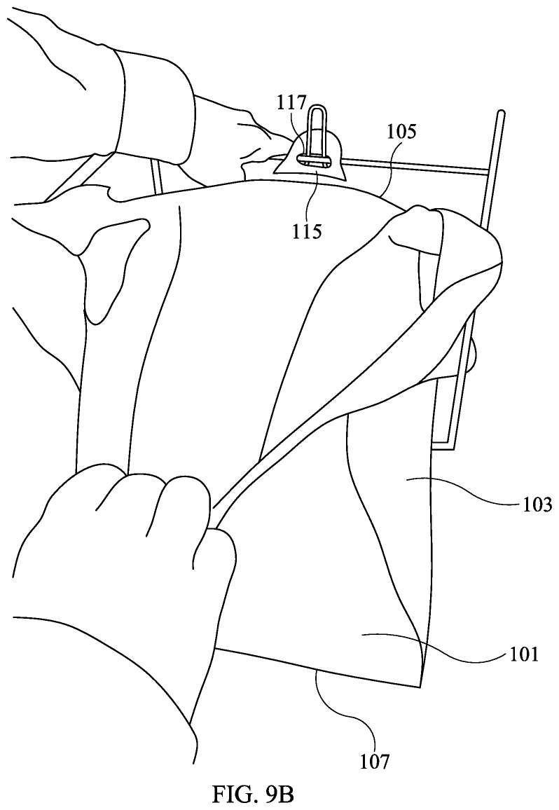

FIGS. 9A-9B shows a bag in accordance with embodiments being opened on a dispenser rack. The bag includes a body 101, sides 103, an opening 105, a bottom 107, and handles 109. The handles 109 are configured to be attached to a rod or similar member extending from the dispenser rack. The bag includes a tab 115 defining an opening 117 and located on only a single side of the bag. The opening 117 is a slit through which a member extends from the dispenser rack. A front side of the bag body 101 is tabless and therefore can be freely pulled away from the rack whilst the back side of the bag is fastened to the rack by the handles 109 and the tab 115, thus opening the bag. The tab is on only a single side of the bag to permit opening of the bag before removal from the rack. Accordingly, the bag may be opened on the rack for filling by pull the tabless front side of the bag away from the rack under a first force.

In some embodiments, the tab 115 is configured to easily separate or tear away from the bag body 101. Accordingly, the bag may be opened for filling under a first force as discussed above, and then separated from the rack under a second stronger force. For example, FIG. 9B shows the bag being separated from tab 115, which remains on the rod of the dispenser rack. As shown in FIG. 9A, before the tab 115 is separated from the bag body 101, and as a front of the bag is removed from the dispenser rack, the tab 115 retains the back side of the bag body 10, causing the bag to open. The bag may be then fully removed, for example after filling, by pulling the bag with sufficient force to separate the tab 115 from the back side of the bag body 101.

Embodiments are shown by way of example, and not by way of limitation in the figures and drawings. While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A bag apparatus, comprising:
a first bag wall;
a first side panel;
a second side panel;
a second bag wall aligned and joined to the first bag wall by the first side panel
and the second side;
a bag bottom;
a first handle extending from the first bag wall and the second bag wall;
a second handle extending from the first bag wall and the second bag wall; and
a tab extending from only the first bag wall and defining an opening.

2. The apparatus of claim 1, the opening of the tab further comprising a slit.

3. The apparatus of claim 1, the first handle further comprising:
an opening defined by the first handle.

4. The apparatus of claim 3, the second handle comprising:
an opening defined by the second handle.

5. The apparatus of claim 1, the first handle forming a loop, and the second handle forming a loop.

6. The apparatus of claim 4, the opening of the first handle and the opening of the second configured to receive a dispenser rack rod for support the bag.

7. The apparatus of claim 6, first side panel and the second side panel being configured to collapse for folding and storing.

8. The apparatus of claim 1, the bag comprising:
a material formed of polypropylene.

9. The apparatus of claim 1, the bag comprising:
a material formed of polyethylene.

10. The apparatus of claim 1, the bag comprising:
a woven material.

11. The apparatus of claim 1, the bag comprising:
a non-woven material.

12. The apparatus of claim 1, the tab further comprising:
a perforated portion connecting the tab to the bag and configured to enable separation of the tab from the bag.

13. The apparatus of claim 1, the tab further comprising:
a separable portion by which the tab is separable from the bag.

14. A method of forming a bag, comprising:
providing a planar, flexible sheet;
forming a pair of handles;
forming a tab defining an opening configured for securing on a dispenser rack.

15. The method of claim 14, the forming the pair of handles further comprising:
forming holes or openings defined in the handles for securing on a dispenser rack.

16. The method of claim 14, comprising:
forming the opening in the tab.

17. The method of claim 14, the forming the tab further comprising:
forming a perforated portion of the tab.

18. The method of claim 14, wherein the tab is configured to permit separation of the tab from the bag.

19. The method of claim 14, the bag comprising polypropylene.

20. The method of claim 14, the bag comprising a non-woven material.
